(19) United States
(12) Patent Application Publication
(10) Pub. No.: US 2025/0381012 A1
(43) Pub. Date: Dec. 18, 2025

(54) DISTRACTION ASSEMBLY COMPRISING A PALATAL DISTRACTOR AND AN ACTIVATION TOOL

(71) Applicant: ECOLE NATIONALE SUPERIEURE DE TECHNIQUES AVANCEES, PALAISEAU (FR)

(72) Inventors: Jérémy DALLARD, Morangis (FR); Jean BOISSON, Paris (FR); Emilie SU, Montreuil (FR); Natacha KADLUB, Paris (FR)

(21) Appl. No.: 18/741,246

(22) Filed: Jun. 12, 2024

(51) Int. Cl. A61C 7/10

(52) U.S. Cl. CPC A61C 7/10

(57) ABSTRACT

The present invention relates to a distraction assembly, comprising: a palatal distractor, comprising an activation rod and a body segmented into a first part comprising a first magnetic assembly composed of at least one first permanent magnet, and into a second part, the rotation of the activation rod causing a relative displacement of the first part and the second part along a distraction axis X, an activation tool removably attached to the first part, comprising a drive member configured to drive the activation rod in rotation, and a second magnetic assembly composed of at least one second, preferably permanent, magnet, the fixed connection between the first part and the activation tool comprising a magnetic coupling between the first magnetic assembly and the second magnetic assembly.

Figure for the abstract: Figure 1

### BACKGROUND OF THE DISCLOSURE

The invention relates to the field of palatal distractors. More precisely, the invention relates to a distraction assembly comprising a palatal distractor and an activation tool.

A palatal distractor is a medical device, which rests in particular on the teeth of a subject and exerts a force on them to enlarge the subject's palate. A palatal distractor is generally put in position by an orthodontist so as to fit the shape of the palate. The force used to enlarge the palate is applied by modifying the width of the palatal distractor along a distraction axis. Enlargement takes place progressively by frequent activation, for example daily.

The state of the art, in particular in document US 2003/013061 A1, already describes an orthodontic tool to adjust the distraction force of a distraction orthodontic screw, in particular a palatal distractor. In this document, a palatal distractor comprises a body segmented into two parts and a threaded distraction rod provided with a reception zone for a hand-held adjustment tool. The adjustment tool comprises a handle and an end provided with a spanner, the spanner being intended to be inserted in the distraction rod to perform the activation, in other words a rotation of the distraction rod in order to achieve a relative displacement of the two parts along a distraction axis.

However, the relative positioning of the adjustment tool, also referred to as the activation tool, and of the palatal distractor is difficult, especially due to the fact that a user handling the adjustment tool cannot easily access the palatal distractor. This access is difficult, whether it is visually or by contact, due to the poor accessibility of the mouth opening. In addition, use of a spanner as an adjustment tool can be unpleasant or injure a subject on whom the palatal distractor is fitted, especially since such a spanner is relatively thin. This activation is demanding and difficult since it requires a highly precise movement, especially to insert the spanner. This movement is difficult to perform on a subject such as a child, for example fidgety, or more generally on a subject having a mouth opening problem. Moreover, the spanner may be difficult to handle by a user, in particular by a nervous parent, who may be frightened to injure their child.

Thus, the invention aims in particular to provide a distraction assembly comprising a palatal distractor and an activation tool, to activate the palatal distractor via the activation tool more simply and more safely.

### Summary of the disclosure

The invention therefore relates to a distraction assembly comprising: - a palatal distractor, which comprises an activation rod and a body segmented into a first part and a second part, the rotation of the activation rod causing a relative displacement of the first part and the second part along a distraction axis X, - an activation tool, which comprises a drive member configured to drive the activation rod in rotation, the activation tool being removably attached to the first part, the first part comprising a first magnetic assembly composed of at least one first permanent magnet, the activation tool comprising a second magnetic assembly composed of at least one second magnet, the fixed connection between the first part and the activation tool comprising a magnetic coupling between the first magnetic assembly and the second magnetic assembly.

Thanks to the first magnetic assembly and the second magnetic assembly, it is easy to make a fixed connection. Thanks to the reversibility of the connection provided with a magnetic coupling, once activation is performed during which the first part and the second part are distracted or brought closer together, a user can easily separate the activation tool from the first part of the palatal distractor. Use of a drive member makes the activation tool even easier to use, since the user does not have to drive the activation rod himself. In addition, such use improves safety during activation, since once the fixed connection is made between the first part of the palatal distractor and the activation tool, there is no risk of injury due to a movement of the activation tool, the activation tool being attached to the first part of the palatal distractor.

According to other optional characteristics of the distraction assembly, taken alone or in combination:

- The second magnetic assembly is composed of at least one second permanent magnet. Thus, the second magnetic assembly is easy to produce.

- The or each first permanent magnet is magnetised in a direction opposite to that of the or one of the second permanent magnets. Thus, each pair of magnets, formed by a first permanent magnet and a second permanent magnet, is such that the first permanent magnet and the second permanent magnet attract each other due to their opposite magnetisations. The magnetic coupling is thus improved.

- At least one, preferably each pair of magnets, formed by a first permanent magnet and a second permanent magnet, is such that the first permanent magnet and the second permanent magnet are identical. Thus, the design is simplified while optimising the magnetic coupling.

- The activation rod is at least partially threaded, the thread being inserted in a tapping of the second part. Thus, the rotation of the activation rod causes the second part to slide relative to the first part along the distraction axis X, in a particularly simple way.

- The distraction assembly comprises a drive mechanism, arranged on the activation tool and/or on the palatal distractor, interposed between an output shaft of a drive electric motor of the drive member and the activation rod, a rotation of the output shaft driving a rotation of the activation rod via the drive mechanism.

- The drive mechanism comprises a first gear and a worm screw or a second gear, the first gear being attached to the activation rod, the worm screw or the second gear being arranged on the activation tool and being driven in rotation by the drive electric motor, the first gear being engaged with the worm screw or the second gear. Thus, the drive mechanism is easy to produce and limits the forces exerted radially relative to the distraction axis X.

- The drive mechanism comprises a flexible drive shaft having a first end and a second end opposite the first end, the first end being kinematically connected to the activation rod, reversibly inclinable through at least an angle of between 15° and 90°, preferably between 25° and 45°, relative to its position axially aligned with the second end, the second end being kinematically connected to the output shaft of the drive electric motor. The use of such a flexible drive shaft simplifies the design while making it easier for a user to handle the activation tool, with regard to the position of the palatal distractor in the mouth of a subject.

- The activation tool comprises a handle configured to be held by the hand of a user. Thus, it is easier to grip the activation tool.

- The at least one first permanent magnet is integrated in an envelope made of biocompatible material, preferably in compliance with standard ISO 10993-1:2018.

- The at least one first permanent magnet is integrated in an envelope made of plastic material. The use of a plastic material makes it possible to produce a light and inexpensive envelope. Preferably, the envelope made of plastic material is produced based on epoxy resin.

- The at least one first permanent magnet is integrated in an envelope made of titanium or stainless steel, preferably non-magnetic stainless steel. The use of titanium or stainless steel makes the envelope extremely strong.

- The at least one first permanent magnet and the first part are integrated in the same material. Thus, the design and manufacture of the palatal distractor are simplified.

- The at least one second permanent magnet is integrated in an envelope made of biocompatible material, preferably in compliance with standard ISO 10993-1:2018.

- The at least one second permanent magnet is integrated in an envelope made of plastic material. The use of a plastic material makes it possible to produce a light and inexpensive envelope. Preferably, the envelope made of plastic material is produced based on epoxy resin.

- The at least one second permanent magnet is integrated in an envelope made of titanium or stainless steel, preferably non-magnetic stainless steel. The use of titanium or stainless steel makes the envelope extremely strong.

- The drive member comprises a drive electric motor. Thus, the drive member is simple to produce. Preferably, the drive electric motor is a stepping electric motor. Thus, the drive electric motor is easier to control.

- The activation tool comprises a rechargeable battery powering the drive electric motor. Thus, the activation tool is simple to use, especially since it requires no specific connections. In addition, since the electrical risk is considerably reduced, the safety of such an activation tool is increased.

- The at least one first permanent magnet and the at least one second permanent magnet are neodymium type, preferably based on Nd₂Fe₁₄B. Thus, these permanent magnets can be particularly compact.

- The activation tool comprises mechanical coupling means, which are removably coupled with the palatal distractor. Preferably, the mechanical coupling means comprise a hook, the hook being removably hooked onto the palatal distractor. The use of such mechanical coupling means, preferably of such a hook, prevents accidental uncoupling of the magnetic coupling, for example due to the forces exerted during the driving procedure. The combination of the at least one first and at least one second permanent magnets and the mechanical coupling means, preferably the hook, thus makes the driving procedure safer. The fixed connection is thus improved while remaining removable.

- The activation tool comprises a stop bearing on the body, preferably at least on the first part. Thus, it is easier to position the activation tool on the palatal distractor.

- The first magnetic assembly comprises a single first permanent magnet and the second magnetic assembly comprises a single second permanent magnet. Thus, the design of the distraction assembly is simplified.

- The first permanent magnet and the second permanent magnet have the same asymmetrical shape in cross-section orthogonal to the axis between their poles, for example an L-shape. Thus, it is easier to position the activation tool on the palatal distractor, due to the fact that the asymmetrical shape has a foolproofing function.

- The first magnetic assembly comprises a plurality of first permanent magnets and the second magnetic assembly comprises a plurality of second permanent magnets, and wherein the fixed connection between the palatal distractor and the activation tool comprises a magnetic coupling between the first permanent magnets of the first magnetic assembly and the second permanent magnets of the second magnetic assembly. Thus, it is easier to position the activation tool on the palatal distractor.

- The first magnetic assembly comprises three first permanent magnets and the second magnetic assembly comprises three second permanent magnets. The use of three pairs of permanent magnets makes positioning easier while optimising the size of the first magnetic assembly and the second magnetic assembly.

- At least two first permanent magnets of the first magnetic assembly are such that the axis between the poles of one of the two first permanent magnets is oblique relative to the axis between the poles of the other of the two first permanent magnets.

- At least two second permanent magnets of the second magnetic assembly are such that the axis between the poles of one of the two second permanent magnets is oblique relative to the axis between the poles of the other of the two second permanent magnets.

- The second magnetic assembly is slidably arranged in a groove of the activation tool. Thus, the magnetic coupling between the first magnetic assembly and the second magnetic assembly can be significantly decreased due to the sliding of the second magnetic assembly in the groove. It is thus easier for a user to separate the activation tool from the palatal distractor, and there is less risk of the palatal distractor becoming unhooked outside the subject on whom the palatal distractor is fitted.

### BRIEF DESCRIPTION OF THE FIGURES

The invention will be better understood on reading the following description, given solely by way of example and with reference to the accompanying drawings in which:

FIG. 1 is a schematic view of a distraction assembly according to a first embodiment, wherein the activation tool is attached to the palatal distractor;

FIG. 2 is a schematic view of a distraction assembly according to the first embodiment, wherein the activation tool is separated from the palatal distractor;

FIG. 3 is a schematic cross-sectional view of a part of a distraction assembly according to a second embodiment, wherein the activation tool is attached to the palatal distractor;

FIG. 4 is a schematic cross-sectional view of a part of a distraction assembly according to the second embodiment, wherein the activation tool is separated from the palatal distractor;

FIG. 5 is a perspective view of a part of a distraction assembly according to the second embodiment, wherein the activation tool is separated from the palatal distractor;

FIG. 6 is a perspective view of a distraction assembly according to a third embodiment, wherein the activation tool is attached to the palatal distractor, and wherein the second magnetic assembly is in an activation position;

FIG. 7 is a perspective view of a distraction assembly according to the third embodiment, wherein the activation tool is attached to the palatal distractor, and wherein the second magnetic assembly is in a separation position.

### DETAILED DESCRIPTION OF THE FIGURES

On all the figures, the same references refer to the same elements.

In this detailed description, the following embodiments are examples. Although the description refers to one or more embodiments, this does not mean that the characteristics apply only to a single embodiment. Simple characteristics of different embodiments may also be combined and/or interchanged to provide other embodiments.

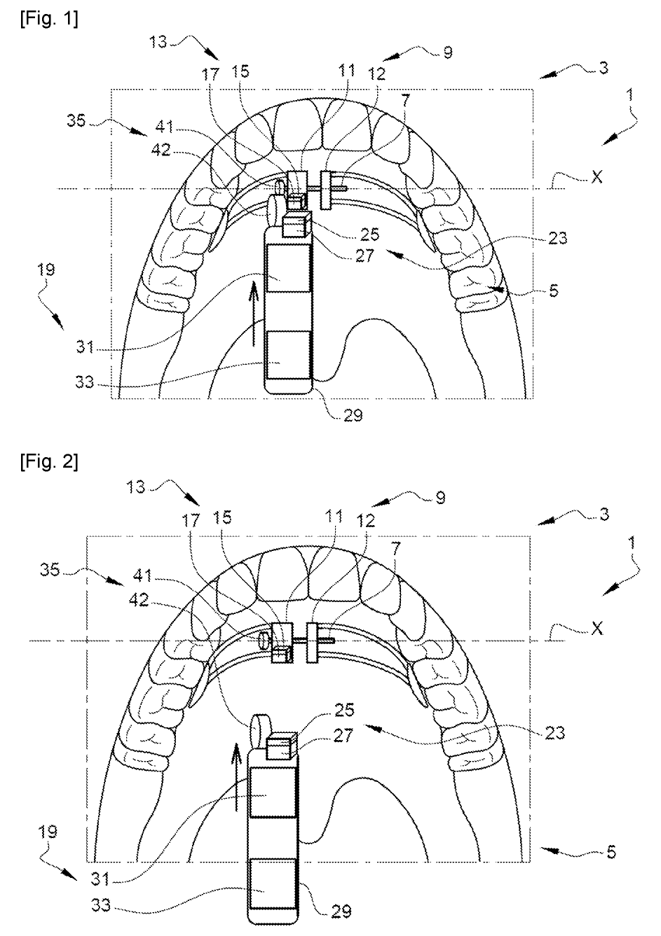

FIG. 1 and FIG. 2 show a distraction assembly according to a first embodiment, designated by the general reference 1, according to various configurations.

The distraction assembly 1 comprises a palatal distractor 3 and an activation tool 5.

The palatal distractor 3 comprises an activation rod 7 and a body 9 segmented into a first part 11 and a second part 12. The activation rod 7, the first part 11 and the second part 12 are made of biocompatible material, preferably in compliance with standard ISO 10993-1:2018. For example, the activation rod 7 is made of stainless steel, preferably non-magnetic, the first part 11 is made of plastic material, preferably based on epoxy resin, and/or made of stainless steel, preferably non-magnetic, and/or titanium, and the second part 12 is made of plastic material, preferably based on epoxy resin, and/or made of stainless steel, preferably non-magnetic, and/or titanium. The rotation of the activation rod 7 causes a relative displacement of the first part 11 and the second part 12 along a distraction axis X. In this embodiment, the activation rod 7 is at least partially threaded, the thread being inserted in a tapping of the second part 12. Thus, the rotation of the activation rod 7 causes the second part 12 to slide relative to the first part 11 along the distraction axis X. The first part 11 comprises a first magnetic assembly 13 composed of at least one first permanent magnet 15. The at least one first permanent magnet 15 is neodymium type, preferably based on Nd₂Fe₁₄B. The at least one first permanent magnet 15 is integrated in an envelope 17 made of biocompatible material, preferably in compliance with standard ISO 10993-1:2018. In this embodiment, the at least one first permanent magnet 15 is integrated in an envelope 17 made of plastic material, preferably based on epoxy resin, or in an envelope made of titanium or stainless steel, preferably non-magnetic stainless steel. For example, the at least one first permanent magnet 15 and the first part 11 are integrated in the same material. In the example shown on FIGS. 1 and 2, the first magnetic assembly 13 comprises a single first permanent magnet 15.

The activation tool 5 comprises a drive member 19, and a second magnetic assembly 23 composed of at least one second magnet, in this embodiment of at least one second permanent magnet 25. The at least one second permanent magnet 25 is neodymium type, preferably based on Nd₂Fe₁₄B. The at least one second permanent magnet 25 is integrated in an envelope 27 made of biocompatible material, preferably in compliance with standard ISO 10993-1:2018. In this embodiment, the at least one second permanent magnet 25 is integrated in an envelope 27 made of plastic material, preferably based on epoxy resin, or in an envelope made of titanium or stainless steel, preferably non-magnetic stainless steel. In the example shown on FIGS. 1 and 2, the second magnetic assembly 23 comprises a single first permanent magnet 25. The activation tool also comprises a handle 29 configured to be held by the hand of a user.

The drive member 19 comprises a drive electric motor 31. In this embodiment, the drive electric motor 31 is a stepping electric motor. To power the drive electric motor 31, the activation tool 5 comprises a rechargeable battery 33 powering the drive electric motor 31, for example of Lithium-Ion type.

The activation tool 5 is removably attached to the first part 11. Thus, as shown on FIG. 1, the activation tool 5 is attached to the first part 11. In this configuration, the fixed connection between the first part 11 and the activation tool 5 comprises a magnetic coupling between the first magnetic assembly 13 and the second magnetic assembly 23. More precisely, the first permanent magnet 15 is magnetised in a direction opposite to that of the second permanent magnet 25, such orientation thus producing the magnetic coupling. The pair of magnets formed by the first permanent magnet 15 and the second permanent magnet 25, is in fact such that the first permanent magnet 15 and the second permanent magnet 25 attract each other due to their opposite magnetisations. The drive member 19 is configured to drive the activation rod 7 in rotation. Once activation has been performed, a user separates the activation tool 5 from the palatal distractor 3 by exerting a force greater than the force generated by the magnetic coupling. As shown on FIG. 2, the activation tool 5 is then separated from the first part 11, and can be removed ready for a new activation.

The distraction assembly 1 comprises a drive mechanism 35, arranged on the activation tool 5 and/or on the palatal distractor 3, inserted between an output shaft of the drive electric motor 31 of the drive member 19 and the activation rod 7. Thus, a rotation of the output shaft causes a rotation of the activation rod 7 via the drive mechanism 35. In the embodiment shown on FIG. 1 and FIG. 2, the drive mechanism 35 comprises a first gear 41 and a second gear 42, the first gear 41 being attached to the activation rod 7, the second gear 42 being arranged on the activation tool 5 and being driven in rotation by the drive electric motor 31. As shown on FIG. 1, the first gear 41 is engaged with the second gear 42.

According to a variant not shown of the first embodiment, the first permanent magnet 15 and the second permanent magnet 25 have the same asymmetrical shape in cross-section orthogonal to the axis between their poles, for example an L-shape.

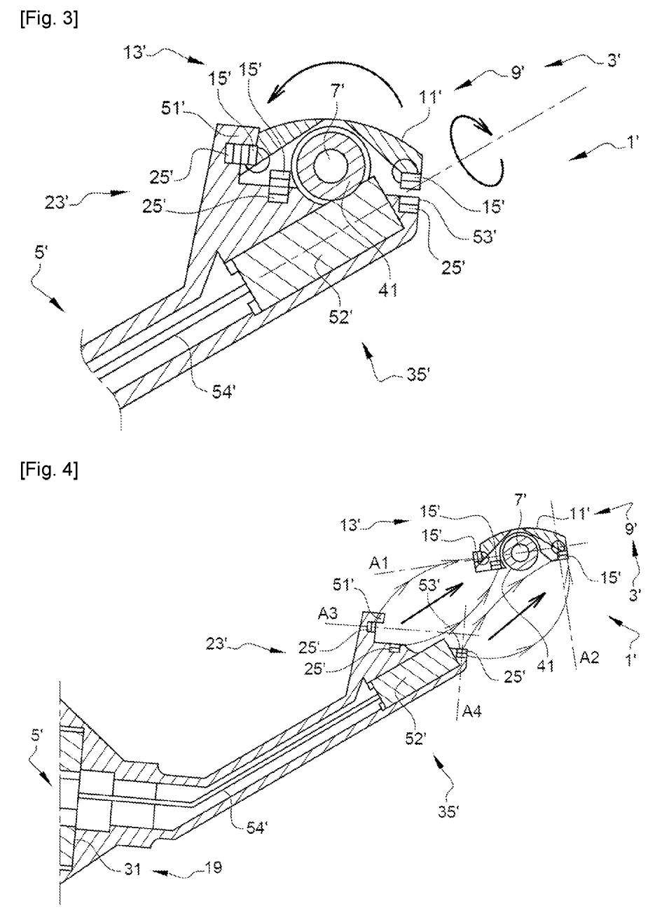

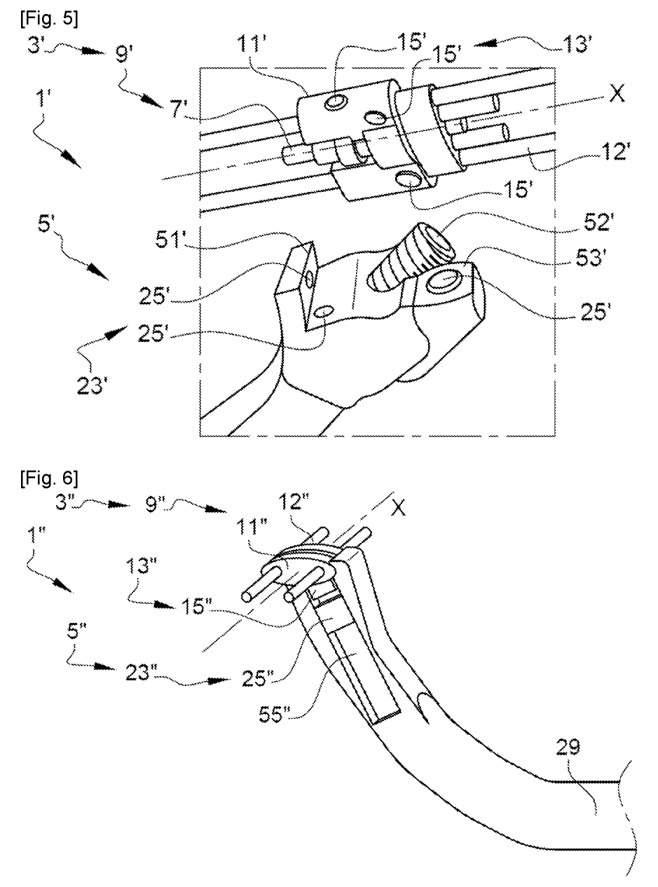

FIG. 3, FIG. 4 and FIG. 5 show a distraction assembly according to a second embodiment, designated by the general reference 1'. The elements forming the distraction assembly 1' according to the second embodiment are similar to those forming the distraction assembly 1 according to the first embodiment, apart from the elements described below.

This distraction assembly 1’ according to the second embodiment differs from the distraction assembly 1 according to the first embodiment mainly in that in the first part 11', the first magnetic assembly 13' comprises a plurality of first permanent magnets 15', and in the activation tool 5’, the second magnetic assembly 23’ comprises a plurality of second permanent magnets 25’. More precisely, in this second embodiment, the first magnetic assembly 13' comprises three first permanent magnets 15' and the second magnetic assembly 23' comprises three second permanent magnets 25'. Thus, the fixed connection between the palatal distractor 3’ and the activation tool 5’ comprises a magnetic coupling between the first permanent magnets 15’ of the first magnetic assembly 13’ and the second permanent magnets 25’ of the second magnetic assembly 23’. More precisely, each first permanent magnet 15' is magnetised in a direction opposite to that of one of the second permanent magnet 25', such orientation thus producing the magnetic coupling. Thus, each pair of magnets, formed by a first permanent magnet 15' and a second permanent magnet 25', is such that the first permanent magnet 15' and the second permanent magnet 25' attract each other due to their opposite magnetisations. In addition, at least one, preferably each pair of magnets, formed by a first permanent magnet 15' and a second permanent magnet 25', is such that the first permanent magnet 15' and the second permanent magnet 25' are identical.

In this second embodiment, at least two first permanent magnets 15' of the first magnetic assembly 13' are such that the axis A1 between the poles of one of the two first permanent magnets 15' is oblique relative to the axis A2 between the poles of the other of the two first permanent magnets 15'. Similarly, at least two second permanent magnets 25' of the second magnetic assembly 23' are such that the axis A3 between the poles of one of the two second permanent magnets 25' is oblique relative to the axis A4 between the poles of the other of the two second permanent magnets 25'.

In addition, in this second embodiment, the activation tool 5' comprises mechanical coupling means, which are removably coupled with the palatal distractor 3'. Preferably, the mechanical coupling means comprise a hook 51’, the hook 51’ being removably hooked to the palatal distractor 3’, as shown on FIG. 3, FIG. 4 and FIG. 5. Since the use of such a hook 51’ prevents accidental uncoupling of the magnetic coupling, the fixed connection is improved while remaining removable. The activation tool also comprises a stop 53' bearing on the body 9', preferably at least on the first part 11'.

In addition, in this second embodiment, instead of a second gear 42, the drive mechanism 35’ comprises a worm screw 52’. Thus, in this second embodiment, the drive mechanism 35' comprises a first gear 41 and a worm screw 52', the first gear 41 being attached to the activation rod 7', the worm screw 52' being arranged on the activation tool 5' and being driven in rotation by the drive electric motor 31. As shown on FIG. 3, the first gear 41 is engaged with the worm screw 52'. In addition, the drive mechanism 35’ comprises a flexible drive shaft 54’ having a first end and a second end opposite the first end. The first end is kinematically connected to the activation rod 7'. "Kinematically connected" means in particular that a rotation about itself of the first end of the flexible drive shaft 54’ causes a rotation of the activation rod 7’. More precisely, the first end of the flexible drive shaft 54’ is, in this example, attached to the worm screw 52’, as shown on FIG. 3. The first end is reversibly inclinable though at least an angle of between 15° and 90°, preferably between 25° and 45°, as shown in particular on FIG. 4, relative to its position axially aligned with the second end. The second end is kinematically connected to the output shaft of the drive electric motor 31. "Kinematically connected" means in particular that a rotation of the output shaft of the drive electric motor causes a rotation about itself of the second end of the flexible drive shaft 54’. As a result, a rotation about itself of the second end of the flexible drive shaft 54’ causes a rotation about itself of the flexible drive shaft 54’, and consequently a rotation about itself of the first end of the flexible drive shaft 54', and a rotation of the activation rod 7’ via the worm screw 52’ and the gear 41.

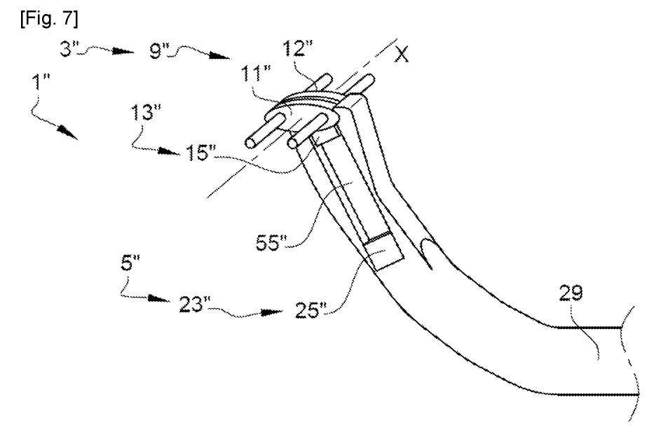

FIG. 6 and FIG. 7 show a distraction assembly 1'' according to a third embodiment. The elements forming the distraction assembly 1'' according to the third embodiment are similar to those forming the distraction assembly 1 according to the first embodiment or to those forming the distraction assembly 1' according to the second embodiment, apart from the elements described below.

In this embodiment, the second magnetic assembly 23’’ is slidably arranged in a groove 55’’ of the activation tool 5’’ between an activation position, shown on FIG. 6, and a separation position, shown on FIG. 7. For example, the user can push the second magnetic assembly with a finger to make it slide. When the activation tool 5’’ is attached to the palatal distractor 3’’, the second magnetic assembly 23’’ is further from the first magnetic assembly 13’’ in the separation position than in the activation position. Thus, it is easier for a user to separate the activation tool 5’’ from the palatal distractor 3’’. For example, the first magnetic assembly 13'' comprises a single first permanent magnet 15'' and the second magnetic assembly 23'' comprises a single second permanent magnet 25''.

The invention is not limited to the embodiments described and other embodiments will be clearly apparent to those skilled in the art.

In particular, the at least one second magnet can be an electromagnet. Thus, when the electromagnet is energised, the activation tool can be attached to the palatal distractor, and when the electromagnet is de-energised, it is easier to separate to activation tool and the palatal distractor. Nevertheless, such a design is more complex and takes up more space compared with the use of permanent magnets.

The first gear 41 can also be replaced by a wheel, preferably based on silicone, to decrease the quantity of residues likely to stick thereon, in particular food when the subject has eaten.

What is claimed is:

1. A distraction assembly, comprising:
a palatal distractor, which comprises an activation rod and a body segmented into a first part and a second part, the rotation of the activation rod causing a relative displacement of the first part and the second part along a distraction axis X,
an activation tool, which comprises a drive member configured to drive the activation rod in rotation, the activation tool being removably attached to the first part,
the first part comprising a first magnetic assembly composed of at least one first permanent magnet,
the activation tool comprising a second magnetic assembly composed of at least one second magnet,
the fixed connection between the first part and the activation tool comprising a magnetic coupling between the first magnetic assembly and the second magnetic assembly.

2. The distraction assembly according to claim 1, wherein the second magnetic assembly is composed of at least one second permanent magnet.

3. The distraction assembly according to claim 1, comprising a drive mechanism, arranged on the activation tool and/or on the palatal distractor, interposed between an output shaft of a drive electric motor of the drive member and the activation rod, a rotation of the output shaft driving a rotation of the activation rod via the drive mechanism.

4. The distraction assembly according to claim 3, wherein the drive mechanism comprises a first gear and a worm screw or a second gear, the first gear being attached to the activation rod, the worm screw or the second gear being arranged on the activation tool and being driven in rotation by the drive electric motor, the first gear being engaged with the worm screw or the second gear.

5. The distraction assembly according to claim 1, wherein the at least one first permanent magnet is integrated in an envelope made of plastic material.

6. The distraction assembly according to claim 1, wherein the activation tool comprises a hook, the hook being removably hooked to the palatal distractor.

7. The distraction assembly according to claim 1, wherein the activation tool comprises a stop bearing on the body, preferably at least on the first part.

8. The distraction assembly according to claim 1, wherein the first magnetic assembly comprises a plurality of first permanent magnets and the second magnetic assembly comprises a plurality of second permanent magnets, and wherein the fixed connection between the palatal distractor and the activation tool comprises a magnetic coupling between the first permanent magnets of the first magnetic assembly and the second permanent magnets of the second magnetic assembly.

9. The distraction assembly according to claim 8, wherein:
at least two first permanent magnets of the first magnetic assembly are such that the axis between the poles of one of the two first permanent magnets is oblique relative to the axis between the poles of the other of the two first permanent magnets, and
at least two second permanent magnets of the second magnetic assembly are such that the axis between the poles of one of the two second permanent magnets is oblique relative to the axis between the poles of the other of the two second permanent magnets.

10. The distraction assembly according to claim 1, wherein the second magnetic assembly is slidably arranged in a groove of the activation tool.
